(19) United States
(12) Patent Application Publication
(10) Pub. No.: US 2006/0126904 A1
(43) Pub. Date: Jun. 15, 2006

(54) Method for multi-model biometric identification and system thereof

(76) Inventors: Yong Jin Lee, Kyungki-do (KR); Kyung Hee Lee, Daejeon-city (KR); Hyung Keun Jee, Daejeon-city (KR); Sung Bum Pan, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/245,586

(22) Filed: Oct. 6, 2005

(30) Foreign Application Priority Data
Dec. 7, 2004 (KR) 10-2004-0102395
Mar. 23, 2005 (KR) 10-2005-0024054

(51) Int. Cl. G06K 9/00

(52) U.S. Cl. 382/115

(57) ABSTRACT

A method for multi-model biometric identification and a system thereof are provided. The method for performing multi-model biometric identification by using a plurality of single biometric identification systems includes: receiving from the single biometric identification system a single biometric comparison value generated by comparing biometric information of a user for whom an identity confirmation request is received, with biometric information of previously registered users; with the single biometric comparison value, generating a comparison value vector for each registered user; in relation to each of registered users, verifying whether or not the comparison value vector is generated by comparison of an identical person and generating a determined value; and by using the determined value, generating a candidate list listing in a predetermined order, users who have highest probabilities of being the user who wants to be identified. Accordingly, by using a variety of biometric characteristics, more accurate identification of a user is enabled.

### CROSS-REFERENCE TO RELATED PATENT APPLICATIONS

This application claims the benefit of Korean Patent Application Nos. 10-2004-0102395, filed on Dec. 7, 2004, and 10-2005-0024054, filed on Mar. 23, 2005, in the Korean Intellectual Property Office, the disclosures of which are incorporated herein in their entirety by reference.

### BACKGROUND OF THE INVENTION

1. Field of the Invention

The present invention relates to a method for multi-model biometric identification and a system thereof, and more particularly, to a multi-model biometric identification method by which multi-model biometric identification is performed by using comparison values of a plurality of single biometric identification systems, and a system thereof.

2. Description of the Related Art

A biometric identification system is a system confirming user's identity by using biometric information of the user. More specifically, the methods for the biometric identification can be broken down broadly to verification and identification. The verification is confirming the identity of a user, and is a method confirming one's identity using a one-to-one comparison. Meanwhile, the identification is a method for finding out a most similar person using a one-to-many comparison of biometric data for a plurality of persons registered in a database, and confirming the identity. That is, while the verification generates a binary class (two class) result value in the form of yes or no, the identification generates a list of candidates in order of decreasing probability as a result value.

Meanwhile, characteristics used in biometric identification includes physical characteristics such as a face, a fingerprint, a vein, and an iris, and behavioral characteristics such as a signature, a manner of walking, and voice. Single biometric identification is a method using only one of these biometric characteristics.

However, it cannot be said that any one method is perfect, because there are advantages and disadvantages according to the characteristics of each physical part to be used. For example, face identification is sensitive to an illumination change and false recognition rate of fingerprint identification greatly increases when the scanner is stained with sweat or moisture. In particular, since there is a limitation of the number of cases that can be expressed by one biometric characteristic, that is, the limitation in the free expression degree of a biometric characteristic, in case of a biometric identification system to which many users are necessarily registered, it is difficult to implement a system with a high performance and reliability, by using only one biometric characteristic. Accordingly, by performing user identification with a variety of biometric characteristics, the performance and reliability of a biometric identification system can be enhanced.

However, since according to biometric characteristics the range and type of biometric data values, and the identification method vary, there are many difficulties in implementing a biometric identification system capable of processing a variety of biometric data items all together. Furthermore, since the identification method generates a candidate list in the form of multi classes and generates a result value, unlike the verification method, there are also difficulties in integrating a plurality of single biometric identification results including many candidates, and generating one candidate list.

### SUMMARY OF THE INVENTION

The present invention provides a method capable of efficiently implementing a multi-model biometric identification system by using a plurality of single biometric identification results, irrespective of the type and number of biometric characteristics to be used and the number of registered users generated in a single biometric identification system, and a system using the method.

According to an aspect of the present invention, there is provided a method for performing multi-model biometric identification by using a plurality of single biometric identification systems, the method including: receiving from the single biometric identification system a single biometric comparison value generated by comparing biometric information of a user for whom an identity confirmation request is received, with biometric information of previously registered users; with the single biometric comparison value, generating a comparison value vector for each registered user; in relation to each registered user, verifying whether or not the comparison value vector is generated by comparison of an identical person and generating a determined value; and by using the determined value, generating a candidate list listing in a predetermined order, users who have highest probabilities of being the user who wants to be identified.

According to another aspect of the present invention, there is provided an apparatus for performing multi-model biometric identification by using a plurality of single biometric identification systems, the apparatus including: an input unit receiving from the single biometric identification system a single biometric comparison value generated by comparing biometric information of a user for whom an identity confirmation request is received, with biometric information of previously registered users; a comparison value vector generation unit generating a comparison value vector for each registered user with the single biometric comparison value; a binary classification unit, in relation to each of registered users, verifying whether or not the comparison value vector is generated by comparison of an identical person and generating a determined value; and an identification list generation unit generating a candidate list listing in a predetermined order, users who have highest probabilities of being the user who wants to be identified, by using the determined value.

According to still another aspect of the present invention, there is provided a computer readable recording medium having thereon a computer program for executing the multi-model biometric identification method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a multi-model biometric identification system according to the present invention;

FIG. 2 is a flowchart of the operations performed by a multi-model biometric identification method according to the present invention;

FIG. 3 is a block diagram showing the training of a binary classification unit of FIG. 1;

FIG. 4 illustrates an example of training the binary classification unit of FIG. 3;

FIG. 5 illustrates an example of a determination boundary found in FIG. 4;

FIG. 6 illustrates another example of a determination boundary found in FIG. 4; and

FIG. 7 is a flowchart of the operations performed by a method for training the binary classification unit in FIG. 1.

### DETAILED DESCRIPTION OF THE INVENTION

A multi-model biometric identification method and a system thereof according to the present invention will now be described more fully with reference to the accompanying drawings, in which exemplary embodiments of the invention are shown.

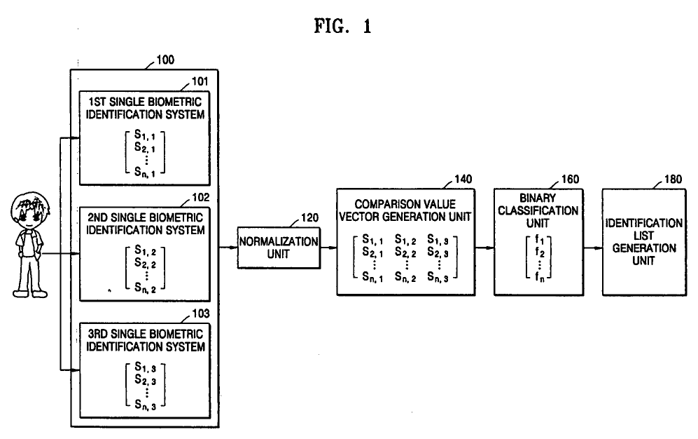

Referring to FIG. 1, a multi-model biometric identification system according to the present invention is formed with a single biometric identification system 100, a normalization unit 120, a comparison value vector generation unit 140, a binary classification unit 160, and an identification list generation unit 180.

The single biometric identification system 100 is formed with a first single biometric identification system 101, a second single biometric identification system 102, and a third single biometric identification system 103. Biometric information of a user requesting confirmation of his identity is input to each of the first single biometric identification system 101, the second single biometric identification system 102, and the third single biometric identification system 103. In each of the single biometric identification systems 101 through 103, the biometric information of the user requesting confirmation of his identity is compared with biometric information of users previously registered in each single biometric identification system 101 through 103.

More specifically, in the first single biometric identification system 101, the biometric information of the user requesting confirmation of his identity is compared with biometric information of each of the users (n users) previously registered in the first single biometric identification system 101, and a biometric information comparison value is generated in relation to each of the registered users. The biometric information comparison value generated in the first single biometric identification system 101 is expressed as [S_{1,1}, S_{2,1}, . . . , S_{n,1}]. Here, S_{n,1} is the biometric information comparison value generated by comparing the biometric information of the user requesting confirmation of his identity with the biometric information of an n-th user registered in the first single biometric identification system 101.

Likewise, in the second single biometric identification system 102, the biometric information of the user requesting confirmation of his identity is compared with biometric information of each of the users (n users) previously registered in the second single biometric identification system 102, and a biometric information comparison value is generated in relation to each of the registered users. The biometric information comparison value generated in the second single biometric identification system 102 is expressed as [S_{1,2}, S_{2,2}, . . . , S_{n,2}]. Here, S_{n,2} is the biometric information comparison value generated by comparing the biometric information of the user requesting confirmation of his identity with the biometric information of an n-th user registered in the second single biometric identification system 102.

In the same manner, in the third single biometric identification system 103, the biometric information of the user requesting confirmation of his identity is compared with biometric information of each of the users (n users) previously registered in the third single biometric identification system 103, and a biometric information comparison value is generated in relation to each of the registered users. The biometric information comparison value generated in the third single biometric identification system 103 is expressed as [S_{1,3}, S_{2,3}, . . . , S_{n,3}]. Here, S_{n,3} is the biometric information comparison value generated by comparing the biometric information of the user requesting confirmation of his identity with the biometric information of an n-th user registered in the third single biometric identification system 103.

The normalization unit 120 normalizes biometric information comparison values input from the single biometric identification systems 101 through 103 so that the values can have a common range and unit values. Because part of the single biometric identification system 100 generates the biometric information comparison values in the form of a similarity degree, and the remaining single biometric identification system 100 generates the comparison values in the form of a dissimilarity degree, in order to unify these two different forms into any one form, normalization is performed through the normalization unit 120. Also, when biometric information comparison values of each of the single biometric identification systems 101 through 103 have values in different ranges, these values need to be unified into values of a common range and for this the normalization is performed.

More specifically, for example, a value in a common range means a value in a range that a user can recognize more conveniently, such as a range from 0 to 1 or 0 to 100. However, here normalization of values in a common range such as the range from 0 to 1 and from 0 to 100 is just an example, and in order to make training of the binary classification unit 160 easier and enhance the classification performance, values in a variety of ranges can be used. In the comparison value vector generation unit 140, a comparison value vector is generated for each of registered users, by using the biometric identification value normalized through the normalization unit 120. Here, when the biometric information comparison values generated by the single biometric identification system 100 and input have a common range and common unit values, the values can be input directly to the comparison value vector generation unit 140 without passing through the normalization unit 120. The comparison value vector generation unit 140 generates a comparison value vector as an n×3 matrix. The comparison value vector generated by comparing the biometric information of the user requesting confirmation of his identity with the biometric information of the first user registered in the single biometric identification system 100, appears as [S_{1,1}, S_{1,2}, S_{1,3}] in the first row. The comparison value vector generated by comparing with the biometric information of the second user appears as [S_{2,1}, S_{2,2}, S_{2,3}] in the second row, and the comparison value vector generated by comparing with the biometric information of the n-th user appears as [S_{n,1}, S_{n,2}, S_{n,3}] in the n-th row.

The binary classification unit 160 verifies the comparison value vectors generated in relation to each of the registered users sequentially to determine whether the comparison value vector is generated by comparison of an identical person or by comparison of different persons, by using data trained in advance. A determined value generated as the result of this verification indicates a reliability of a probability of being a comparison value vector generated by comparison of an identical person, or being a comparison value vector generated by comparison of different persons, or indicates a final similarity degree (or dissimilarity degree) comparing multi-model biometric information. Here, the determined value generated in the binary classification unit 160 as a result of the verification does not indicate a digital value appearing as either ‘0’ or ‘1’, but indicates any one value of analog values continuously appearing from ‘0’ to ‘1’. More specifically, the binary classification unit 160 generates a determined value as an n×1 matrix. The determined value of the first user registered in the single biometric identification system 100 appears as f₁ in the first row. The determined value of the second user appears as f₂ in the second row, and the determined value of the n-th user appears as fₙ in the n-th row.

The identification list generation unit 180 generates an identification list of users in order of decreasing probabilities or increasing probabilities of being the user requesting confirmation of his identity, by using the determined values of the binary classification unit 160 in relation to each of the registered users.

Though for easier explanation of the present invention the number of the single biometric identification systems 100 is shown as 3 in FIG. 1, the types and number of biometric identification systems to be used in the present invention are not limited to this. Also, even with an identical biometric information item, by employing different identification methods, a plurality of single biometric identification systems can be formed and used.

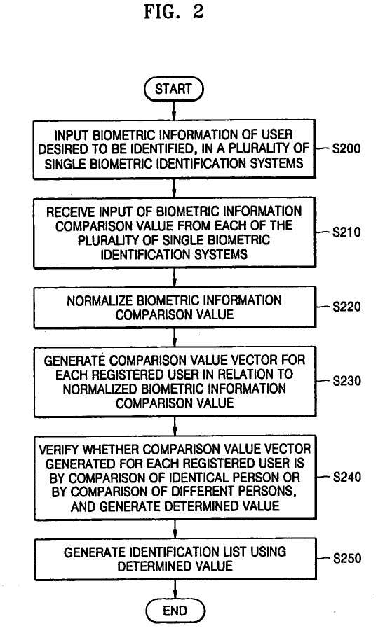

FIG. 2 is a flowchart of the operations performed by a multi-model biometric identification method according to the present invention. Referring to FIG. 2, first, biometric information of a user who wants confirmation of his identity is input to a plurality of single biometric identification systems 100 in operation S200.

Next, the input of a biometric information comparison value from each of the plurality of the single biometric identification systems 100 is received in operation S210. Here, the biometric information comparison value is a value generated by comparing the biometric information of the user requesting confirmation of his identity, with the biometric information of users previously registered in each of the single biometric identification systems 100.

Next, the biometric information comparison value input in operation S210 is normalized in operation S220. Here, normalization is to make the biometric information comparison values input from each of the single biometric identification systems 100 have a common range and unit values. Because part of the single biometric identification system 100 generates the biometric information comparison values in the form of a similarity degree, and the remaining single biometric identification system 100 generates the comparison values in the form of a dissimilarity degree, in order to unify these two different forms into any one form, normalization is performed. Also, when biometric information comparison values of each of the single biometric identification systems 101 through 103 have values in different ranges, these values need to be unified into values of a common range and for this the normalization is performed.

Next, in relation to the normalized biometric information comparison value, a comparison value vector for each of the users registered in the single biometric identification systems 100 is generated in operation S230. Here, when the biometric information comparison values generated by the single biometric identification system 100 in operation S210 and input have a common range and common unit values, operations S230 can be directly performed without performing operation S220.

Next, the comparison value vectors generated in relation to each of the registered users in operation S230 are sequentially verified to determine whether the comparison value vector is generated by comparison of an identical person or by comparison of different persons, by using a binary classification unit trained in advance, and determined values are generated in operation S240. Here, the determined value indicates a reliability of a probability of being a comparison value vector generated by comparison of an identical person, or being a comparison value vector generated by comparison of different persons, or indicates a final similarity degree (or dissimilarity degree) comparing multi-model biometric information. Also, the determined value does not indicate a digital value appearing as either ‘0’ or ‘1’, but indicates any one value of analog values continuously appearing from ‘0’ to ‘1’.

Next, by using the size of the determined value generated in operation S240, an identification list of registered users in order of decreasing probabilities of being the user requesting confirmation of his identity is generated in operation S250.

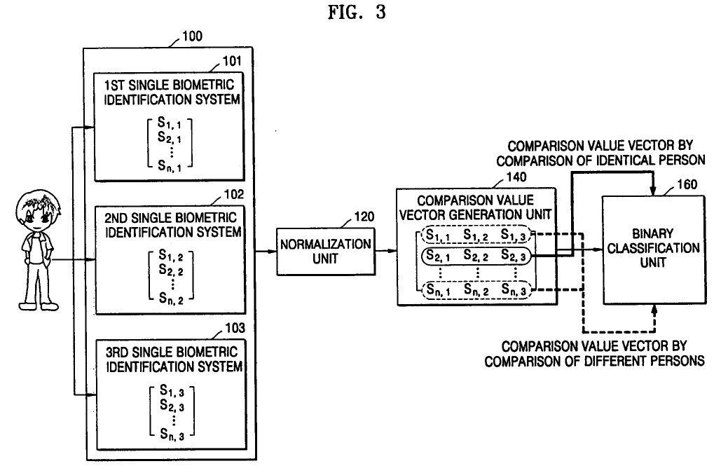

FIG. 3 is a block diagram showing the training of a binary classification unit of FIG. 1. Referring to FIG. 3, when the number of users registered in the single biometric identification system 100 is n, one comparison value vector by comparison of an identical person and (n−1) comparison value vectors by comparison of different persons are input to the binary classification unit 160 from the comparison value vector generation unit 140. FIG. 3 shows training the binary classification unit 160 by using biometric information of the second user registered in the single biometric identification system 100. That is, one comparison value vector by comparison of an identical person and (n−1) comparison value vectors by comparison of different persons are input to the binary classification unit 160, and based on the inputs, the binary classification unit 160 performs training by analyzing corresponding comparison value vectors.

As a result of this training, the binary classification unit 160 is able to determine whether the comparison value vector input from the comparison value vector generation unit 140 is a comparison value vector generated by comparison of an identical person or by comparison of different persons.

For those parts not explained in FIG. 3, refer to the explanation of FIG. 1.

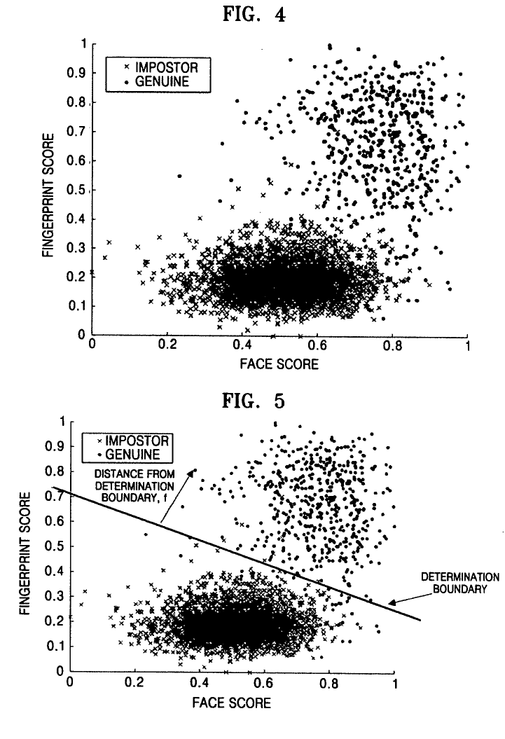

FIG. 4 illustrates an example of training the binary classification unit of FIG. 3. Referring to FIG. 4, the comparison value vectors generated by using biometric information on the face and fingerprint are expressed on a 2-dimensional plane. Comparison value vectors generated by comparison of an identical person (Genuine) are indicated by blue points, and comparison value vectors generated by comparison of different persons (Impostor) are indicated by red x marks. Here, training the binary classification unit means finding out a determination boundary so that a vector generated by comparison of an identical person can be clearly distinguished from a vector generated by comparison of different persons.

FIG. 5 illustrates an example of a determination boundary found in FIG. 4. Referring to FIG. 5, an example of a linear determination boundary determined by using data provided for training is shown.

Here, the location and type of the linear determination boundary are determined according to the used data and the training algorithm of the binary classification unit, and in the present invention, the algorithm is not limited to a predetermined binary classification algorithm. The data provided for training means data of known sources (whether each vector is generated by comparison of an identical person or by comparison of different persons is known in relation to the data provided for training).

Accordingly, the determined value is calculated by using the distance between the linear determination boundary as described above and a comparison value vector. That is, the farther a comparison value vector is located away from the determination boundary in the blue color side, the higher the probability that the comparison value vector is generated by comparison of an identical person is, and the farther a comparison value vector is located away from the determination boundary in the red color side, the higher the probability that the comparison value vector is generated by comparison of different persons is. Accordingly, when this is applied to an actual multi-model biometric identification system, if an arbitrary comparison value vector with an unknown source (whether the comparison value vector is generated by comparison of an identical person or by comparison of different persons is not known) is input, the source can be determined based on the determination boundary.

Though for easier explanation of the present invention two single biometric information items of the face and fingerprint are explained here, the present invention is not limited to this and can be expanded to a case using 3 or more single biometric information items.

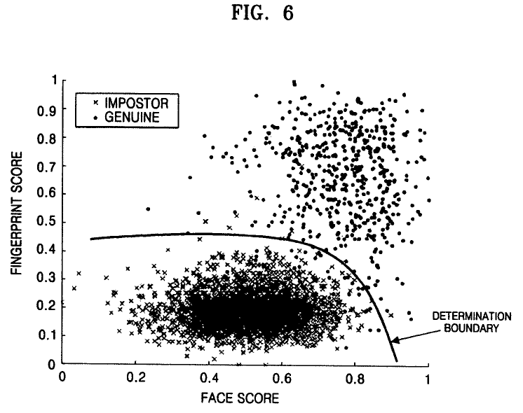

FIG. 6 illustrates another example of a determination boundary found in FIG. 4. Referring to FIG. 6, an example of a nonlinear determination boundary found out by using the data provided for training is shown. In FIG. 5, the determination boundary is linear, but in FIG. 6, the determination boundary is not linear. For those parts not explained in FIG. 6, refer to the explanation of FIG. 5.

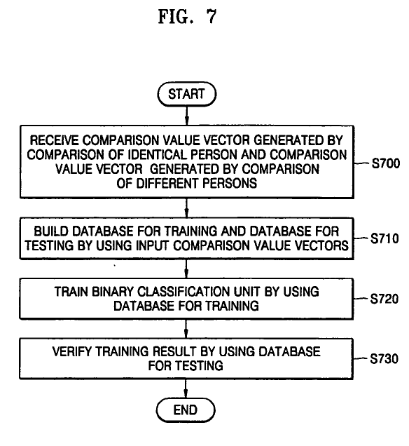

FIG. 7 is a flowchart of the operations performed by a method for training the binary classification unit in FIG. 1. Referring to FIG. 7, first, the binary classification unit 160 receives inputs of comparison value vectors generated by comparison of an identical person and comparison value vectors generated by comparison of different persons from the comparison value vector generation unit 140 in operation S700.

Next, by using the comparison value vectors generated by comparison of an identical person and the comparison value vectors generated by comparison of different persons input in operation S700, a database for training and a database for testing are established in operation S710.

Next, by using the database for training established in operation S710, the binary classification unit 160 is trained in operation S720. Through this training, the binary classification unit 160 is able to distinguish comparison value vectors generated by comparison of an identical person from comparison value vectors generated by comparison of different persons. The determined value in the trained binary classification unit 160 indicates the reliability of a probability of being a vector generated by comparison of an identical person.

Next, comparison value vectors stored in the database for testing are input to the binary classification unit 160 trained in operation S720, and by using the performance result of the binary classification unit 160, the training result is verified in operation S730.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

As described above, by suggesting a method for implementing a multi-model biometric identification using single biometric identification results, a method for multi-model biometric identification and a system thereof with higher performance and reliability can be formed.

The multi-model biometric identification method and the system using single biometric identification result suggested in the present invention simplify the single biometric identification result in the form of multi classes into a binary class. By doing so, many single biometric identification systems can be easily integrated.

Also, irrespective of the number of candidates generated in the single biometric identification system, a multi-model biometric identification method and a system thereof capable of expressing a plurality of single biometric identification results in one unified comparison value can be implemented.

What is claimed is:

1. A method for performing multi-model biometric identification by using a plurality of single biometric identification systems, the method comprising:
receiving from one of the single biometric identification systems a single biometric comparison value generated by comparing biometric information of a user for whom an identity confirmation request is received, with biometric information of previously registered users;
with the single biometric comparison value, generating a comparison value vector for each registered user;
for each registered user, verifying whether or not the comparison value vector is generated by comparison of an identical person and generating a determined value; and
by using the determined value, generating a candidate list listing in a predetermined order, users who have highest probabilities of being the user for whom an identity confirmation request is received.

2. The method of claim 2, wherein the receiving of the single biometric comparison value comprises:
transmitting the biometric information of the user for whom an identity confirmation request is received, to each of the single biometric identification systems; and
receiving a single biometric identification comparison value transmitted by each of the single biometric identification systems.

3. The method of claim 2, wherein the single biometric identification comparison value is a value obtained by comparing the biometric information of the user for whom an identity confirmation request is received, with biometric information of users previously registered in the plurality of single biometric identification systems, and numerically expressing the degree of the correspondence.

4. The method of claim 1, wherein the generating of the comparison value vector comprises:
normalizing the single biometric identification comparison values; and
by using the normalized single biometric identification comparison values, setting a comparison vector for each of the registered users.

5. The method of claim 4, wherein when the single biometric comparison values have similarity degrees and dissimilarity degrees which cause inconsistency, the normalizing of the single biometric identification comparison value reduces the degree of at least one of the similarity degrees and dissimilarity degrees in order to keep consistency.

6. The method of claim 4, wherein when the ranges of the single biometric identification comparison values are different, the normalizing of the single biometric identification comparison value is to make the ranges identical.

7. The method of claim 1, wherein the generating of the determined value comprises:
verifying the comparison value vector by using a binary classification unit to determine whether the vector is by comparison of an identical person or by comparison of different persons; and
through the verifying, generating a determined value indicating whether the vector is by comparison of an identical person or by comparison of different persons.

8. The method of claim 7, wherein the binary classification unit is trained.

9. The method of claim 8, wherein a method for training the binary classification unit comprises:
by using the single biometric identification result generated in the single biometric identification system, collecting input value vectors generated by comparison of an identical person and input value vectors generated by comparison of different persons, and generating a database for training;
by using the single biometric identification result generated in the single biometric identification system, collecting input value vectors generated by comparison of an identical person and input value vectors generated by comparison of different persons, and generating a database for testing;
by inputting comparison value vectors by comparison of an identical person and comparison value vectors by comparison of different persons from the database for training to the binary classification unit, training the binary classification unit; and
verifying the training result of the binary classification unit by using the database for testing.

10. An apparatus for performing multi-model biometric identification by using a plurality of single biometric identification systems, the apparatus comprising:
an input unit receiving from the single biometric identification system a single biometric comparison value generated by comparing biometric information of a user for whom an identity confirmation request is received, with biometric information of previously registered users;
a comparison value vector generation unit generating a comparison value vector for each registered user with the single biometric comparison value;
a binary classification unit, in relation to each registered user, verifying whether or not the comparison value vector is generated by comparison of an identical person and generating a determined value; and
an identification list generation unit generating a candidate list listing in a predetermined order, users who have highest probabilities of being the user who wants to be identified, by using the determined value.

11. The system of claim 10, wherein the single biometric identification comparison value is a value obtained by comparing the biometric information of the user for whom an identity confirmation request is received, with biometric information of users previously registered in the plurality of single biometric identification systems, and numerically expressing the degree of the correspondence.

12. The system of claim 10, further comprising:
a normalization unit normalizing the single biometric identification comparison value,
wherein the comparison value vector generation unit generates a comparison value vector for each of the registered users, by using the normalized biometric identification comparison value.

13. The system of claim 12, wherein when the single biometric comparison values have similarity degrees and dissimilarity degrees which cause inconsistency, the normalizing of the single biometric identification comparison value reduces the degree of at least one of the similarity degrees and dissimilarity degrees in order to keep consistency.

14. The system of claim 12, wherein when the ranges of the single biometric identification comparison values are different, the normalizing of the single biometric identification comparison value is to make the ranges identical.

15. The system of claim 10, wherein the binary classification unit generates a determined value by verifying the comparison value vector in the binary classification unit to determine whether the vector is by comparison of an identical person or by comparison of different persons, and the determined value indicates whether the vector is by comparison of an identical person or by comparison of different persons.

16. The system of claim 15, wherein the binary classification unit is trained.

17. A computer readable recording medium having embodied thereon a computer program for executing a method comprising:receiving from one of the single biometric identification systems a single biometric comparison value generated by comparing biometric information of a user for whom an identity confirmation request is received, with biometric information of previously registered users;
with the single biometric comparison value, generating a comparison value vector for each registered user;
for each registered user, verifying whether or not the comparison value vector is generated by comparison of an identical person and generating a determined value; and
by using the determined value, generating a candidate list listing in a predetermined order, users who have highest probabilities of being the user for whom an identity confirmation request is received
